(19) United States
(12) Patent Application Publication
(10) Pub. No.: US 2005/0213124 A1
(43) Pub. Date: Sep. 29, 2005

(54) Image processing system and method

(76) Inventors: Yujiro Takeshita, Kagoshima-ken (JP); Katsumi Komagamine, Kagoshima-ken (JP); Masaru Hoshino, Nagano-ken (JP); Nobuhisa Takabayashi, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/054,363

(22) Filed: Feb. 8, 2005

(30) Foreign Application Priority Data
Feb. 13, 2004 (JP) 2004-036407

(51) Int. Cl. H04N 1/56; H04N 1/60

(52) U.S. Cl. 358/1.9; 358/504; 358/518

(57) ABSTRACT

Provided is a printing profile setting device that is characterized in including:storage means for storing a profile of a reference printing device and reference patch data; printing control means for having a target printing device printed a target patch based on the reference patch data; data capture means for capturing, via an image reading device, reference color data representing a printing color of a reference patch that is printed by the reference printing device based on the reference patch data, and target color data representing a printing color of the target patch; and setting means for comparing the reference color data and the target color data in the same color space, and based on a comparison result, setting a profile derived by correcting a profile of the reference printing device as a profile of the target printing device.

### REFERENCES TO RELATED APPLICATIONS

The entire disclosure including the specification, drawings, and abstract of this Japanese application No. 2004-036407, filed on Feb. 13, 2004, is incorporated herein by reference.

### BACKGROUND OF THE INVENTION

### FIELD OF THE INVENTION

Equipment such as image scanners, displays, and printers handles image data using a color space depending on what equipment. With such data handling using the equipment-dependent color space, a problem arises when a document is scanned by an image scanner, and the resulting image data is printed by a printer. That is, the printed document looks different in color from the original document. The printed document also looks different in color from the image data on a display. For the purpose of reducing such a discrepancy of color reproduction, the color matching technology has been developed. In the color matching technology, image data is delivered via an equipment-independent color space referred to as Profile Connection Space (PCS). For image input using an image scanner or others, the image-scanner-dependent color space is converted into the PCS for the resulting image data. For image output using a display or a printer, on the other hand, the PCS is converted into the display- or printer-dependent color space for the image data.

For converting the PCS into the equipment-dependent color space, and vice versa, used is a profile that is data storing a lookup table for the use of such conversions. Including such a profile enables the equipment to perform color matching using the PCS with other arbitrary equipment also including a profile. The profile for color matching includes, for example, an ICC profile that is the international standards of the color management technology.

The issue here is that a printing device such as printer is known for changing its characteristics with time, causing property degradation of color reproduction. Even with no change of characteristics with time, the color reproduction varies depending on what type of printer is in use. Such property degradation of color reproduction with time, and variation of color reproduction due to varying printer type can be both solved by going through a profile creation again.

Such profile recreation, however, requires a colorimeter exemplified by spectrophotometer, and an application program for creating a profile based on the output of the calorimeter. The calorimeter is generally expensive, and purchasing a set of calorimeter and application program together with a printer is difficult for ordinary users in terms of cost, and after purchase, operating the set for profile creation is difficult for the users in terms of handling. What is more, profile creation using a calorimeter generally takes a long time.

### SUMMARY OF THE INVENTION

The present invention is proposed in consideration of the above problems, and an object thereof is to provide a printing profile setting device, system, method, and program all capable of matching the property of color reproduction of a target printing device to that of a reference printing device without using a calorimeter.

(1) In order to achieve the object, a printing profile setting device includes: a storage means for storing a profile of a reference printing device and reference patch data; a printing control means for having a target printing device printed a target patch based on the reference patch data; a data capture means for capturing via an image reading device, reference color data representing a printing color of a reference patch that is printed by the reference printing device based on the reference patch data, and target color data representing a printing color of the target patch; and a setting means for comparing the reference color data and the target color data in the same color space, and based on a comparison result, setting a profile derived by correcting a profile of the reference printing device as a profile of the target printing device.

Such a printing profile setting device, via an image reading device, captures both the reference color data representing the printing color of the reference patch, and the target color data representing the printing color of the target patch. Such data capturing enables comparison between the reference color data and the target color data in the same color space. The comparison result is then used as a basis for profile setting, i.e., a profile derived by correcting the profile of the reference printing device is set as a profile of the target printing device. In this manner, property of color reproduction of the target printing device can be matched to that of the reference printing device without using a calorimeter.

(2) The data capture means may capture the reference color data and the target color data solely via the image reading device.

With such a printing profile setting device, the comparison can be made between the reference color data and the target color data in a color space dependent on the image reading device.

(3) The data capture means may have the image reading device read at a time the reference patch and the target patch.

With such a printing profile setting device, the property of color reproduction of the target printing device can be correctly adjusted without suffering from temporal characteristics change of the image reading device.

(4) The setting means may compare the reference color data and the target color data in a color space that is standardized separately from the image reading device.

With such a printing profile setting device, the image reading device for capturing the target color data representing the printing color of the target patch may be deferent from the image reading device for capturing the target color data representing the printing color of the target patch.

(5) The setting means may specify the target color data representing a color most similar to the color represented by any of the reference color data based on the comparison result, and may set, as the profile of the target printing device, a profile corresponding to a mapping as a result of combining a mapping replacing a first output value of the profile of the reference print device corresponding to the reference color data with a second output value of the profile of the reference printing device corresponding to the specified target color data, and a mapping corresponding to the profile of the reference printing device.

(6) In order to achieve the above-described object, a printing profile setting system includes: an image reading device for reading an optical image of a reference patch printed by a reference printing device based on reference patch data, and an optical image of a target patch printed by a target printing device based on the reference patch data; and a printing profile setting device, including: storage means for storing a profile of the reference printing device and the reference patch data; printing control means for having the target printing device printed the target patch based on the reference patch data; data capture means for capturing, via the image reading device, reference color data representing a printing color of the reference patch, and target color data representing a printing color of the target patch; and setting means for comparing the reference color data and the target color data in the same color space, and based on a comparison result, setting a profile derived by correcting a profile of the reference printing device as a profile of the target printing device.

With such a printing profile setting system, the property of color reproduction of the target printing device can be matched to that of the reference printing device without using a calorimeter.

(7) In order to achieve the above-described object, a printing profile setting method includes the steps of: having a target printing device printed a target patch based on reference patch data; reading a reference patch printed by a reference printing device based on the reference patch data and the target patch, and capturing reference color data representing a printing color of the reference patch and target color data representing a printing color of the target patch; and comparing the reference color data and the target color data in the same color space, and based on a comparison result, setting a profile derived by correcting a profile of the reference printing device as a profile of the target printing device.

With such a printing profile setting method, the property of color reproduction of the target printing device can be matched to that of the reference printing device without using a calorimeter.

(8) In order to achieve the above-described object, a printing profile setting program product for allowing a computer to function various functions, includes: storage means for storing a profile of a reference printing device and reference patch data; printing control means for having a target printing device printed a target patch based on the reference patch data; data capture means for capturing, via an image reading device, reference color data representing a printing color of a reference patch that is printed by the reference printing device based on the reference patch data, and target color data representing a printing color of the target patch; and setting means for comparing the reference color data and the target color data in the same color space, and based on a comparison result, setting a profile derived by correcting a profile of the reference printing device as a profile of the target printing device.

With such a printing profile setting program, the property of color reproduction of the target printing device can be matched to that of the reference printing device without using a calorimeter.

Note here that the means provided in the present invention are functionally implemented by hardware resources defined by function with the device structure, the hardware resources defined by function by a program, or combination of such hardware resources. These means are not restrictive, in terms of function, to those implemented by hardware resources physically independent from one another.

### BRIEF DESCRIPTION OF THE DRAWINGS

The accompanying drawings are all the simplified schematic representation of an example reflecting the principles of the present invention. For eliminating the possibility of harming the clarity of the present invention, factors and details apparent to those skilled in the art not described.

FIG. 1 is a data flow diagram according to an example of the present invention;

FIG. 2 is a schematic diagram of the example;

FIG. 3 is a block diagram of the example;

FIG. 4A is a schematic diagram of an image reading device of the example;

FIG. 4B is a block diagram of the image reading device of the example;

FIG. 5 is a schematic diagram showing reference patch data of the example;

FIG. 6A is a schematic diagram showing printing using a reference printer;

FIG. 6B is a schematic diagram showing printing before adjustment to be made by the reference printer;

FIG. 6C is a schematic diagram showing printing after adjustment to be made by the reference printer;

FIG. 7 is a schematic diagram showing a target patch of the example;

FIG. 8 is a schematic diagram showing how a profile is corrected in the example; and

FIG. 9 is a sequence chart of the example.

### DETAILED DESCRIPTION OF THE INVENTION

In the below, an embodiment of the present invention is described based on examples. Although the examples are described in detail, the present invention is not restrictive thereto and understood as being quite wide in scope. In order to determine the true scope of the present invention, the accompanying claims are to be referred to.

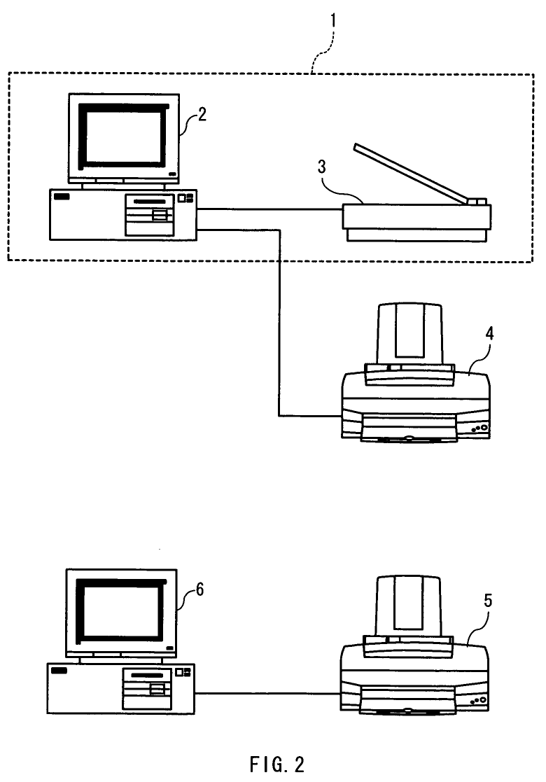

FIG. 2 is a schematic diagram showing a printing profile setting system 1 according to an example of the present invention. The printing profile setting system 1 is provided with a personal computer (PC) 2 serving as a printing profile setting device, and an image scanner 3 serving as an image reading device. In the system, the PC 2 and the image scanner 3 are connected to each other for communications therebetween. A target printer 4 serving as a target printing device is connected to the PC 2 for communications therewith. A reference printer 5 serving as a reference printing device is connected to a PC 6, or may be connected to the PC 2.

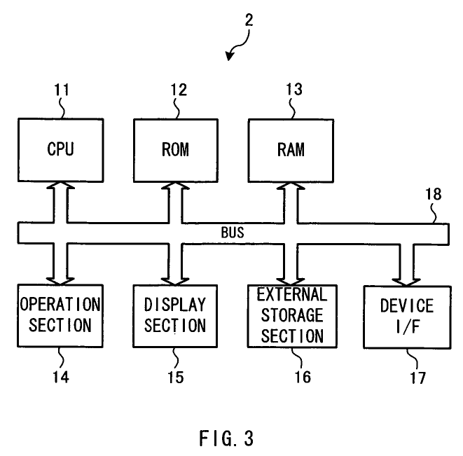

FIG. 3 is a block diagram showing the hardware structure of the PC 2. The PC 2 is provided with a CPU 11, ROM 12, RAM 13 serving as storage means, an operation section 14, a display section 15, an external storage section 16 serving also as the storage means, and a device Interface (I/F) 17, those of which are all connected to one another by a bus 18. The operation section 14 includes a mouse, a keyboard, and others. The display section 15 includes a display exemplified by CRT or LCD, a display controller, and others. The external storage section 16 includes a hard disk, a hard disk controller, and others, and stores various programs and data including an operating system (OS), a printer driver, a profile of the reference printer 5, a scanner driver, a profile of the image scanner 3, and reference patch data, for example. The device I/F 17 is configured in conformity with the communications standards exemplified by RS-232C, Bluetooth, USB, and others. The device I/F 17 is connected to both the image scanner 3 and the target printer 4 for communications therewith. The CPU 11 executes a program stored in the ROM 12 or the external storage section 16 for exercising control over the PC 2. In this example, a printing profile setting program is installed as a printer driver or scanner driver. The CPU 11 serves as printing control means and setting means by running the printer driver, and serves as data capture means by running the scanner driver. The ROM 12 is memory previously storing various programs and data, and the RAM 13 is memory temporarily storing various programs and data. These programs and data may be downloaded from a given server over a network, or may be read out, for input, from computer-readable recording media such as removal memory.

Described next is the image scanner 3.

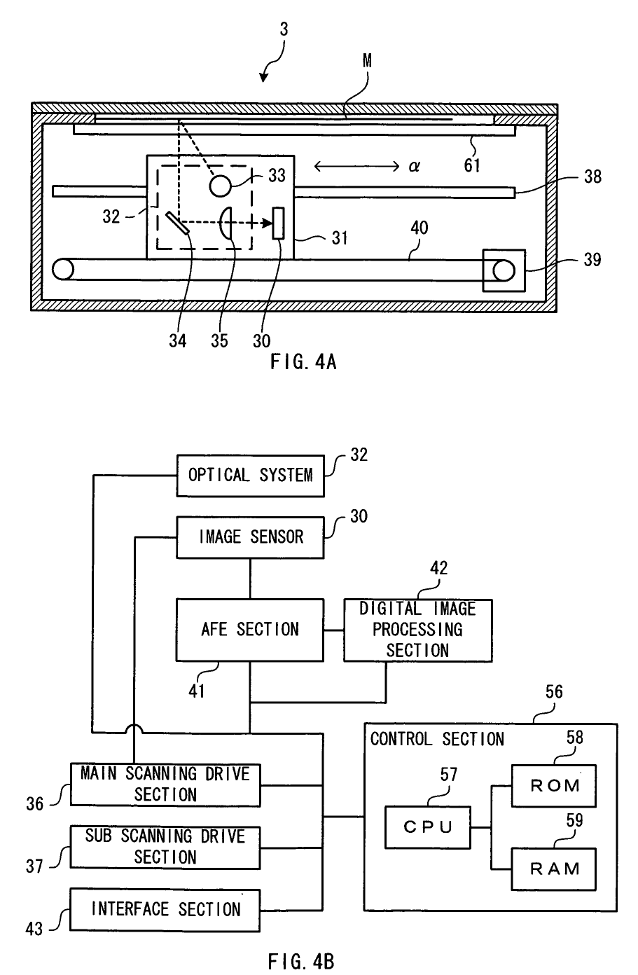

FIG. 4A is a schematic diagram of the image scanner 3, and FIG. 4B is a block diagram showing the hardware structure of the image scanner 3.

An optical system 32 is provided with a light source 33, a mirror 34, a lens 35, and the like. The light source 33 includes a fluorescent tube lamp or others, and the mirror 34 and the lens 35 form on a linear image sensor 30 an optical image of a document M that is illuminated by the light source 33.

The linear image sensor 30 includes photoreceptors such as photodiodes linearly arranged in the vertical direction viewed from the front of FIG. 4, and is provided to a carriage 31. The linear image sensor 30 stores electrical charges for a predetermined length of time, and outputs an electrical signal corresponding to the incoming light amount using a Charge Coupled Device (CCD), a MOS transistor switch, or others. Here, the electric charges are those derived by subjecting, to optical-electrical conversion, light of any predetermined wavelength spectrum such as visible radiation, infrared radiation, ultraviolet radiation, and others. The linear image sensor 30 carries three rows of photoreceptors, and these rows are respectively formed with an on-chip primary-color filter, each of R (Red), G (Green), and B (Blue). Herein, such color filters may be four-complementary-color filters of C (Cyan), M (Magenta), Y (Yellow), and G (Green), or three-complementary-color filters of CMY. Alternatively, a plurality of filters may be formed to a row.

A main scanning drive section 36 is a drive circuit for outputting, to the linear image sensor 30, driving pulses needed to drive the linear image sensor 30. The main scanning drive section 36 is exemplified by synchronous signal generators, drive timing generators, or others.

A sub scanning drive section 37 is provided with a slide axis 38 that is laid across the axial direction of the linear image sensor 30 to hold the carriage 31 to freely slide, a stepping motor 39, a drive belt 40, a drive circuit, and others. By the stepping motor 39 pulling the carriage 31 with the drive belt 40, the linear image sensor 30 and the document M move relatively in the direction of a (sub scanning direction) of FIG. 4, thereby enabling scanning of two-dimensional images.

An analog front end (AFE) section 41 includes an analog signal processing section, an A/D converter, and others. The analog signal processing section applies an analog signal process to the electrical signal coming from the linear image sensor 30. Here, the analog signal process includes amplification, noise reduction, and others. The A/D converter quantizes the electrical signal coming from the analog signal processing section, and outputs the resulting digitally-represented signal of a given bit length.

A digital image processing section 42 processes the output signal coming from the AFE section 41, e.g., gamma correction, interpolation of defective pixels using pixel interpolation algorithm, shading compensation, image signal sharpening, and color space conversion. Alternatively, such various processes to be executed by the digital image processing section 42 may be replaced by those of a computer program to be run by the control section 56.

The interface (I/F) section 43 is configured in conformity with the communications standards exemplified by RS-232C, Bluetooth, USB, and others, and is connected to the PC 2 for communications therewith.

The control section 56 is provided with a CPU 57, ROM 58, and RAM 59. The CPU 57 runs a computer program stored in the ROM 58 for exercising control over the components in the image scanner 3. The ROM 58 is memory previously storing various programs and data, and the RAM 59 is memory temporarily storing various programs and data.

Described next is reference patch data.

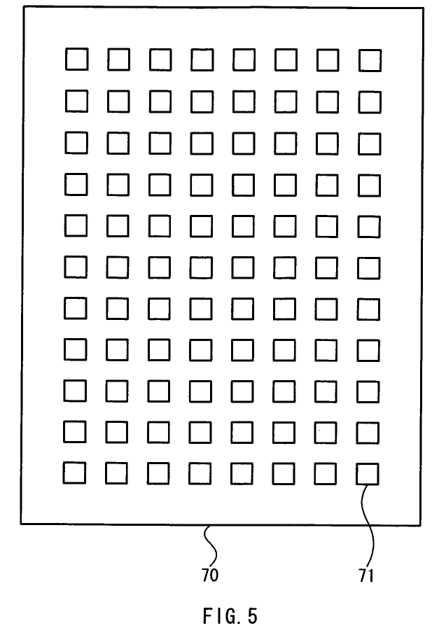

FIG. 5 is a schematic diagram showing a printing paper 70 printed with an image represented by the reference patch data. The reference patch data is image data represented in the RGB color space, and is set with a plurality of pixel values as color data for printing of N different colors for each of the channels of R, G, and B, i.e., N×N×N different colors. Assuming that a digital image has 8 bits, N takes a value in the range of 1 to 255. The colors each represented by the corresponding color data are printed on the printing paper 70 in their specific area in any given order. The given order means from darkest to lightest, for example, and may be arbitrarily set. In FIG. 5, a plurality of small boxes 71 are each representing the specified area for the printed color.

Described next is how to adjust the color reproduction.

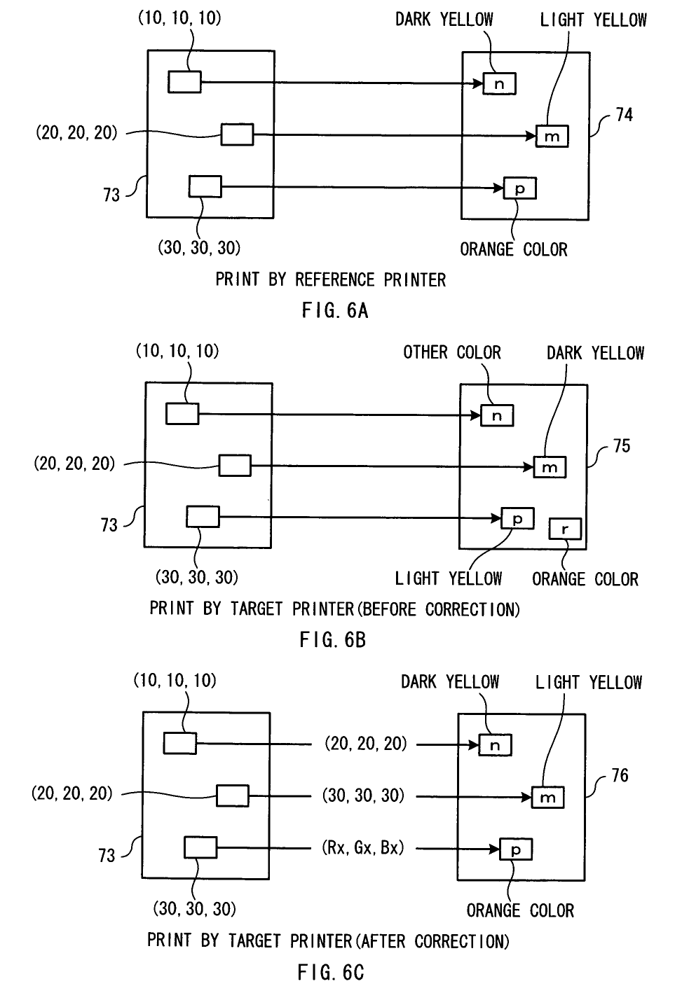

FIG. 6A is a schematic diagram showing printing using the reference printer 5, FIG. 6B is a schematic diagram showing printing before adjustment to be made by the target printer 4, and FIG. 6C is a schematic diagram showing printing after adjustment to be made by the target printer 4. Exemplary reference patch data 73 shown in the drawing is set with (10, 10, 10) as color data for a color to be printed on the area n of the printing paper, (20, 20, 20) as color data for a color on the area m, and (30, 30, 30) as color data for a color on the area p. FIG. 6A shows an exemplary case where the reference patch data 73 is printed using the reference printer 5, and the area n of the printing paper 74 will be printed in dark yellow, the area m will be printed in light yellow, and the area p will be printed in orange color. FIG. 6B shows another exemplary case where such reference patch data 73 is printed using the target printer 4. With the target printer 4, the printing result shows color differences from the result of the reference printer 5 due to property degradation of color reproduction as a result of its characteristics change with time. More in detail, the area n of the printing paper 75 is printed not in dark yellow but in a different color, the area m is printed in dark yellow, and the area p is printed in light yellow. The orange color is printed on some other area r. With such color differences as shown in FIG. 6B, for color adjustment specifically for the area n, for example, the color data (10, 10, 10) for the area n may be replaced with (20, 20, 20) before printing by the target printer 4. FIG. 6C shows the result of such printing, and the area n in the printing paper 76 is printed in dark yellow using the target printer 4. This is applicable not only to the reference patch data 73 but also to any digital image for printing by the target printer 4. That is, replacing, if included, every color data of (10, 10, 10) in the digital image with the color data of (20, 20, 20) will derive a printing result with no color difference observed for dark yellow. Similarly, replacing, if included, every color data of (20, 20, 20) with the color data of (30, 30, 30) will derive a printing result with no color difference observed for light yellow. As to the orange color, locating the area printed in orange, and then replacing the color data of (30, 30, 30) in the digital image with the color data (Rx, Gx, Bx) for thus located area will derive a printing result with no color difference observed for orange color. This is true to other colors.

To be more specific, for adjustment of color reproduction, a comparison is first made between the printing paper 74 as a printing result of the reference patch data using the reference printer 5, and the printing paper 75 as a printing result of the reference patch data using the target printer 4. Through comparison as such, the reference patch data is defined by what color data requires replacement with what color data, and thus derived correspondence is used as a basis for replacement in a digital image prior to printing. In the below, the printing paper as a printing result of the reference patch data using the reference printer 5 is referred to as reference patch, and the printing paper as a printing result of the reference patch data using the target printer 4 is referred to as target patch.

Described next is a printing profile setting program.

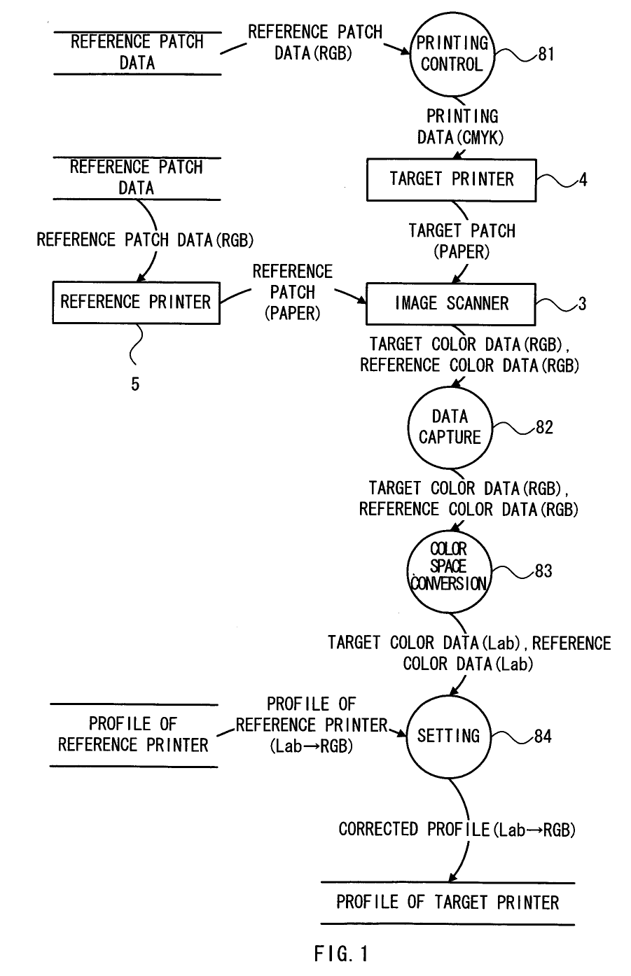

FIG. 1 is the data flow diagram of a printing profile setting program. The printing profile setting program includes a printing control process 81, a data capture process 82, a color space conversion process 83, and a setting process 84.

In the printing control process 81, the target printer 4 is controlled by the reference patch data so that the target patch is printed.

In the data capture process 82, the image scanner 3 is so controlled as to scan at a time the reference patch and the target patch, thereby capturing both reference color data representing the reference patch, and target color data representing the target patch. Here, the reference color data and the target color data may be captured as a piece of image data or each different image data. By scanning the reference patch and the target patch at a time, the color reproduction can be adjusted by the image scanner 3 even with its characteristics change with time. This is because if the reference color data can be compared with the target color data in the same color space, the target printer 4 can be adjusted in color reproduction using a profile of the reference printer 5.

In the color space conversion process 83, thus captured reference color data and target color data are both converted into the Lab color space using a profile of the image scanner 3. Through conversion as such, the reference color data and the target color data are converted into the same color space, which is standardized independently from the image scanner 3.

In the setting process 84, the reference color data is compared with the target color data in the Lab color space, and based on the comparison result, the profile of the reference printer 5 is corrected. Herein, the color space for comparison between the reference color data and the target color data is not necessarily the Lab color space. As long as the reference color data and the target color data are captured by the same image scanner, such data comparison may be made in the Lab or RGB color space. The RGB color space is equipment-dependent, and thus is restricted for use only when the reference and target color data are captured by a single image scanner, or otherwise failing to properly correct the profile. Therefore, when the reference color data and the target color data are captured by each different image scanner, the Lab color space is a requirement for data comparison, or any other standardized color spaces except the RGB color space will do as an alternative thereto.

More in detail, the reference color data is compared with the target color data on the basis of color data using the following equation (1). The reference color data is defined which color data is closest in color to which color data in the target color data.
ΔE=√[(L₁−L₂)²+(a₁−a₂)²+(b₁−b₂)²] (1)

In the equation (1), L1, a1, and b1 all denote the color data in the reference color data, and L2, a2, and b2 all denote the color data in the target color data. Calculating the equation (1) leads to the color differences observed between any two color data, and the smaller ΔE means the smaller color differences therebetween. The smaller the color differences, it means that the two color data are closer in color, and thus defining the color showing the smallest color differences can tell which color is closet. In this example, the quasi-Newton method is used to define which color data in the target color data is representing the closest color, i.e., the quasi-Newton method is used to specify which color data minimizes the value of equation (1).

Described next is how the color data is defined using the quasi-Newton method.

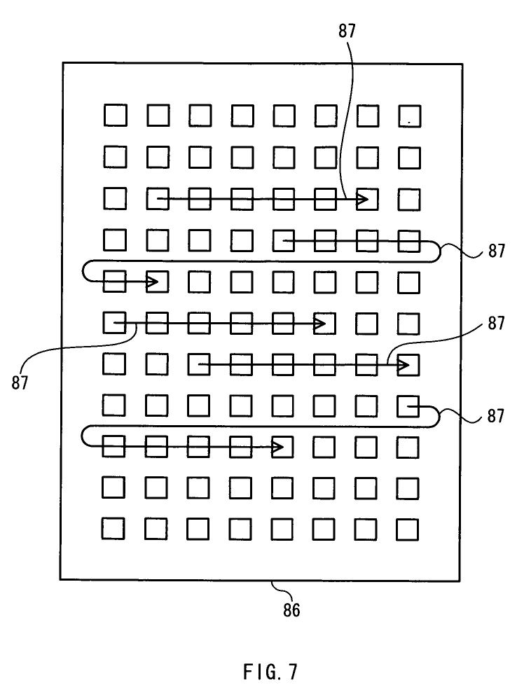

FIG. 7 is a schematic diagram showing a target patch 86. The quasi-Newton method is for searching for a point that minimizes the objective function. A predetermined equation corresponding to the objective function is used to calculate a point for the next move from the current point, and such a calculation is repeated until deriving a point of convergence where the objective function is minimized. The quasi-Newton method is a known algorithm, and thus is not described in more detail. Here, the point where the objective function is minimized may be calculated by the Newton method, or any other methods of unconstrained optimization will do.

In the setting process 84, one specific color data is first selected in the reference color data. In the target color data, any one color data is set at random as an initial point using random numbers, and from thus set initial point, a search is repeated using the quasi-Newton method until predetermined requirements are satisfied. Here, specifically, the predetermined requirements include the comparison frequency, for example. There may be cases where no convergence is achieved with some initial points, and with this being the case, the search is terminated when the comparison is made for a specific number of times. If convergence is achieved, the search is terminated at the point of convergence. After the search is completed, to the extent of the search, specified is one target color data with which the value of ΔE is minimized. Such a search is repeated for 100 times, for example, with each randomly-set initial point, and the search results are compared with one another to find the target color data minimizing the value of ΔE. In FIG. 7, a plurality of arrows 87 each show a range covered by a one-time search. As such, by executing the above-described process to every color data in the reference color data, the color data representing the color closest to the target color data is specified in the reference color data. Randomly setting an initial point eliminates the need for comparison with every color data in the target color data so that the time for such comparison can be shortened. The initial point may be set at the position where the closest color is likely to be found. For example, with reference to the coordinates of the selected color data, an initial point may be set in a specific range therefrom. Instead of randomly setting an initial point, every color data in the target color data may be subjected to comparison.

In the above process, there may be cases where any one specific color data in the target color data is specified for some different color data in the reference color data. If this is the case, the color reproduction is not exactly adjusted. To prevent such a possibility, the following measures are to be taken in the setting process 84. That is, if anyone specific color data in the target color data is specified for two different color data in the reference color data, two other color data are specified regarding one of two different color data, i.e., one color data representing a color second closer to one of two different color data, and another representing a color third closer to one of two different color data. Based on such three color data, the color data is interpolated before being specified. Such data interpolation is an arbitrarily-selectable design matter. The other color data is interpolated in a similar manner. As a result of such data interpolation, a one-to-one relationship is established between the color data in the reference color data and the target color data.

In the setting process 84, after every color data is specified with color data representing its closest color, the resulting correspondence is used as a basis to specify, for every color data in the reference patch data, which color data is to be replaced therewith. As a specific example, assuming that the color data of (10, 10, 10) in the reference color data is specified with the color data of (20, 20, 20) in the target color data. In this case, in the setting process 84, correspondence is established between the color data of the reference patch data corresponding to the color data of (10, 10, 10) in the reference color data, and the color data of the reference patch data corresponding to the color data of (20, 20, 20) in the reference color data. A lookup table is then created for defining thus established correspondence. Note here that the reference patch data is not necessarily set with every color, and thus no correspondence is established at this time for colors not found in the reference patch data. In view thereof, in the setting process 84, the colors not found in the lookup table are interpolated using the colors found therein so that the correspondence is interpolated for the colors not included in the reference patch data. Such color interpolation is an arbitrarily-selectable design matter, and thereafter, the lookup table is fully created. After creation of the lookup table, in the setting process 84, thus created lookup table is used as a basis to correct the profile of the reference printer 5.

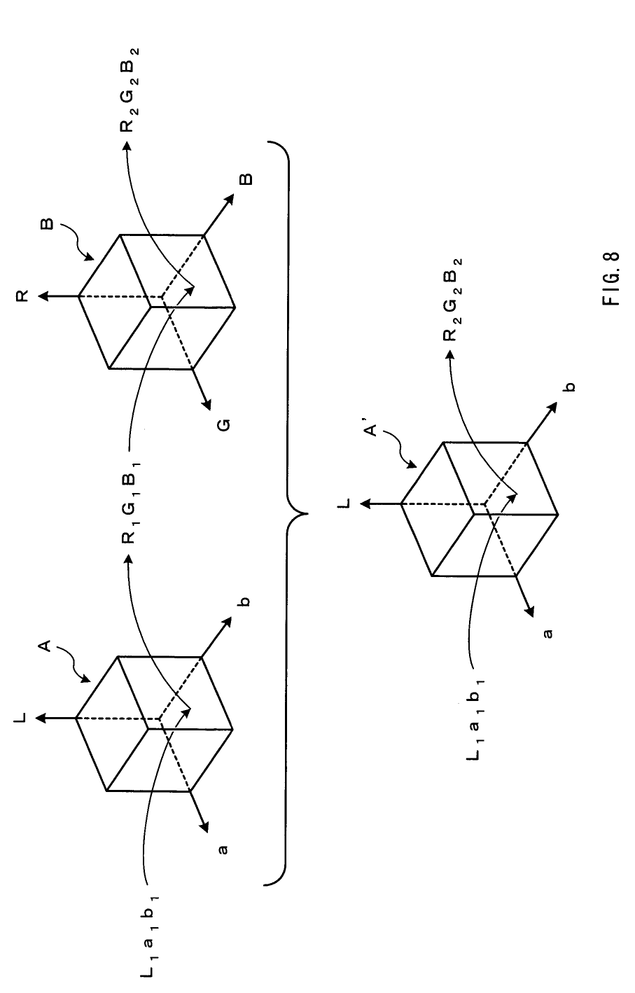

FIG. 8 is a schematic diagram for illustrating how the profile of the reference printer 5 is to be corrected. A lookup table A in the drawing is the one stored in the profile of the reference printer 5, and a lookup table B is the one created in the setting process 84. Using lookup tables allows to uniquely specify the RGB output value corresponding to the Lab or RGB input value, and thus the lookup tables can be three-dimensionally represented. In the setting process 84, the lookup tables A and B are combined together, and the resulting lookup table A′ is stored in the profile of the reference printer 5 so that the profile is corrected. After such profile correction, a profile of the target printer 4 is accordingly set. In case digital images are delivered via the PCS, the reference printer 5, which is conventionally used by the PC 2 for conversion from PCS to RGB color space, converts with the profile of the target printer 4 automatically.

The mapping in Claims for replacing the first output value with the second output value is equivalent to the lookup table B, and the mapping corresponding to the profile of the reference printer is equivalent to the lookup table A. The profile of the mapping as a result of combination of the lookup tables A and B is equivalent to the profile storing the lookup table A′.

Described next is the process flow for setting a profile of the target printer 4.

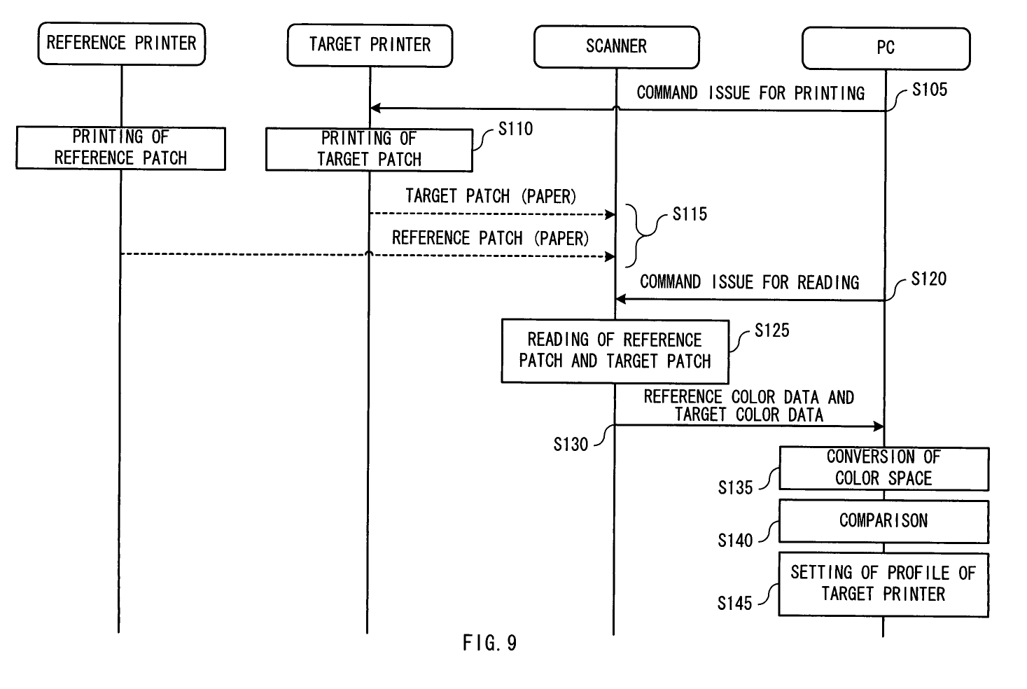

FIG. 9 is a sequence chart showing the process flow for setting the profile of the target printer 4.

In step S105, the PC 2 issues a command to the target printer 4 to print reference patch data.

In step S110, the target printer 4 prints a target patch based on the reference patch data.

In step S115, a user places, on the image scanner 3, both a target patch previously printed by the reference printer 5, and the target patch printed in step S110.

In step S120, the PC 2 issues a command to the image scanner 3 to start scanning.

In step S125, the image scanner 3 scans the reference and target patches at a time so that reference color data and target color data are generated.

In step S130, thus generated reference color data and target color data are forwarded to the PC 2.

In Step S135, the PC 2 performs color space conversion for the reference and target color data, i.e., from RGB to Lab.

In step S140, the PC 2 compares the reference color data with the target color data in the Lab color space.

In step S145, based on the comparison result, the profile of the reference printer 5 is corrected, and the resulting profile is set as the profile of the target printer 4.

After such profile setting to the target printer 4 and onwards, the color data of the incoming digital image via the PCS is replaced accordingly by the lookup table A′. Therefore, derived is the printing result of the digital image showing less color differences from the printing result using the reference printer 5.

In this example, described is a case of adjusting the property of color reproduction of the target printer 4 with reference to the color reproduction of the reference printer 5, which is of the type different from the target printer 4. This is not restrictive, and the reference and target printers 4 and 5 may be a single printer. With this being the case, specifically, the newly-bought target printer 4 maybe regarded as the reference printer 5, and a reference patch is printed right after the purchase for later use. When the target printer 4 is degraded in color reproduction, a target patch is printed thereby for comparison with the reference patch so that the property of color reproduction can be adjusted. In this manner, the user can adjust the color reproduction of his/her target printer 4 even if it is degraded. In an alternative manner, the reference patch may be provided by the manufacturer of the target printer 4 for adjustment use as above.

According to the present invention, in the printing profile setting system 1, the image scanner 3 is used to capture the reference color data each representing printing colors of a reference patch, and the target color data each representing printing colors of a target patch. This enables comparison between the reference color data and the target color data in the same color space. Based on the comparison result, because a profile derived by correcting the profile of the reference printer 5 can be set as a profile of the target printer 4, the same property of color reproduction can be derived between the target printer 4 and the reference printer 5 without using a calorimeter. Further, the image scanner is generally less expensive than the calorimeter, and thus using the image scanner can reduce the cost for adjusting the color reproduction of the target printer 4 compared with the case of using the calorimeter. What is more, using no calorimeter eliminates the need to operate the calorimeter or an application program for profile creation, and thus ordinary users can find the profile easy to correct. Still further, the image scanner generally requires less time for scanning than the calorimeter, thereby favorably shortening the time taken for correction. In this view, assuming that the manufacturer of the target printer 4 is expected to adjust the property of color reproduction for the respective target printers 4, such adjustment can be done in a short time, successfully leading to less development cost.

Herein, the image scanner may be of a so-called stand-alone type requiring no control by the PC 2. With this being the case, the PC 2 may acquire reference color data and target color data via nonvolatile recording media such as removal memory. In an alternative structure, the image scanner and the target printer may be in a piece, and such a two-in-one device and the PC 2 may configure a printing profile setting system. In this example, exemplified as an image reading device is an image scanner. This is not restrictive, and the image reading device may be a digital camera. It is understood that numerous other combinations and sub combinations can be devised for those skilled in the art without departing from the scope of the invention.

1. A printing profile setting device, comprising:
storage means for storing a profile of a reference printing device and reference patch data;
printing control means for having a target printing device printed a target patch based on the reference patch data;
data capture means for capturing, via an image reading device, reference color data representing a printing color of a reference patch that is printed by the reference printing device based on the reference patch data, and target color data representing a printing color of the target patch; and
setting means for comparing the reference color data and the target color data in the same color space, and based on a comparison result, setting a profile derived by correcting a profile of the reference printing device as a profile of the target printing device.

2. The printing profile setting device according to claim 1, wherein
the data capture means captures the reference color data and the target color data solely via the image reading device.

3. The printing profile setting device according to claim 2, wherein
the data capture means has the image reading device read at a time the reference patch and the target patch.

4. The printing profile setting device according to claim 1, wherein
the setting means compares the reference color data and the target color data in a color space that is standardized separately from the image reading device.

5. The printing profile setting device according to claim 1, wherein
the setting means specifies the target color data representing a color most similar to a color represented by any of the reference color data based on the comparison result, and sets, as the profile of the target printing device, a profile corresponding to a mapping as a result of combining a mapping replacing a first output value of the profile of the reference print device corresponding to the reference color data with a second output value of the profile of the reference printing device corresponding to the specified target color data, and a mapping corresponding to the profile of the reference printing device.

6. A printing profile setting system, comprising:
an image reading device for reading an optical image of a reference patch printed by a reference printing device based on reference patch data, and an optical image of a target patch printed by a target printing device based on the reference patch data; and
a printing profile setting device, including:
storage means for storing a profile of the reference printing device and the reference patch data;
printing control means for having the target printing device printed the target patch based on the reference patch data;
data capture means for capturing, via the image reading device, reference color data representing a printing color of the reference patch, and target color data representing a printing color of the target patch; and
setting means for comparing the reference color data and the target color data in the same color space, and based on a comparison result, setting a profile derived by correcting a profile of the reference printing device as a profile of the target printing device.

7. A printing profile setting method, comprising the steps of:
having a target printing device printed a target patch based on reference patch data;
reading a reference patch printed by a reference printing device based on the reference patch data and the target patch, and capturing reference color data representing a printing color of the reference patch and target color data representing a printing color of the target patch; and
comparing the reference color data and the target color data in the same color space, and based on a comparison result, setting a profile derived by correcting a profile of the reference printing device as a profile of the target printing device.

8. A printing profile setting program product for use with a computer operable with:
storage means for storing a profile of a reference printing device and reference patch data;
printing control means for having a target printing device printed a target patch based on the reference patch data;
data capture means for capturing, via an image reading device, reference color data representing a printing color of a reference patch that is printed by the reference printing device based on the reference patch data, and target color data representing a printing color of the target patch; and
setting means for comparing the reference color data and the target color data in the same color space, and based on a comparison result, setting a profile derived by correcting a profile of the reference printing device as a profile of the target printing device.
